(19) United States
(12) Patent Application Publication
(10) Pub. No.: US 2020/0349188 A1
(43) Pub. Date: Nov. 5, 2020

(54) TAGGING AN OBJECT WITHIN AN IMAGE AND/OR A VIDEO

(71) Applicant: Oath Inc., New York, NY (US)

(72) Inventors: Matthew Robert Ahrens, Champaign, IL (US); Yugandhar Reddy Boyapally, Champaign, IL (US)

(21) Appl. No.: 16/401,569

(22) Filed: May 2, 2019

(51) Int. Cl. G06F 16/58; G06F 16/783; G06K 9/00; G06T 7/70; G06T 7/00; G06F 3/16

(52) U.S. Cl. CPC G06F 16/5866; G06F 16/7844; G06F 16/7837; G06F 3/167; G06T 7/70; G06T 7/97; G06K 9/00671

(57) ABSTRACT

One or more computing devices, systems, and/or methods are provided. A first image captured via a first camera is received. The first image is analyzed to identify a first object within the first image. An object tag comprising information associated with the first object is generated. The object tag and/or object information associated with the first object are stored. A second image captured via a second camera is received. The first object is identified within the second image based upon the second image and/or the object information. A representation of the object tag may be displayed via a display device. Alternatively and/or additionally, a location of the first object may be determined based upon the second image. Alternatively and/or additionally, an audio message indicative of the object tag may be output via a speaker.

### BACKGROUND

Services, such as websites, applications, etc., may provide platforms for viewing images and/or videos comprising indications of information associated with objects.

### SUMMARY

In accordance with the present disclosure, one or more computing devices and/or methods are provided. In an example, a first image captured via a first camera is received. The first image is analyzed to identify a first object within the first image. An object tag comprising information associated with the first object is generated. The object tag and/or object information associated with the first object are stored. A second image captured via a second camera is received. The first object is identified within the second image based upon the second image and/or the object information. A representation of the object tag is displayed via a display device.

In an example, a first image captured via a first camera is received. The first image is analyzed to identify a first object within the first image. An object tag comprising information associated with the first object is generated. The object tag and/or object information associated with the first object are stored. A second image captured via a second camera is received. The first object is identified within the second image based upon the second image and/or the object information. A location of the first object is determined based upon the second image.

In an example, a first image captured via a first camera is received. The first image is analyzed to identify a first object within the first image. An object tag comprising information associated with the first object is generated. The object tag and/or object information associated with the first object are stored. A second image captured via a second camera is received. The first object is identified within the second image based upon the second image and/or the object information. An audio message indicative of the object tag is output via a speaker.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for tagging an object within an image and/or a video with information and/or later detecting the object and retrieving the information.

FIG. 5A is a component block diagram illustrating an example system for tagging an object within an image and/or a video with information and/or later detecting the object and retrieving the information, where a first client device displays a first real-time video.

FIG. 5B is a component block diagram illustrating an example system for tagging an object within an image and/or a video with information and/or later detecting the object and retrieving the information, where a first client device displays a first set of indicators associated with a first set of objects.

FIG. 5C is a component block diagram illustrating an example system for tagging an object within an image and/or a video with information and/or later detecting the object and retrieving the information, where a first client device displays a tag interface.

FIG. 5D is a component block diagram illustrating an example system for tagging an object within an image and/or a video with information and/or later detecting the object and retrieving the information, where a second client device displays a second real-time video.

FIG. 5E is a component block diagram illustrating an example system for tagging an object within an image and/or a video with information and/or later detecting the object and retrieving the information, where a second client device displays a representation of a first object tag associated with a second object.

FIG. 6A is a component block diagram illustrating an example system for tagging an object within an image and/or a video with information and/or later detecting the object and retrieving the information, where a first client device displays a first real-time video.

FIG. 6B is a component block diagram illustrating an example system for tagging an object within an image and/or a video with information and/or later detecting the object and retrieving the information, where a first client device displays an indicator associated with a first object.

FIG. 6C is a component block diagram illustrating an example system for tagging an object within an image and/or a video with information and/or later detecting the object and retrieving the information, where a first client device displays a tag interface.

FIG. 6D is a component block diagram illustrating an example system for tagging an object within an image and/or a video with information and/or later detecting the object and retrieving the information, where a first client device displays a second real-time video.

FIG. 6E is a component block diagram illustrating an example system for tagging an object within an image and/or a video with information and/or later detecting the object and retrieving the information, where a first client device displays a representation of a first object tag associated with a first object.

FIG. 7 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

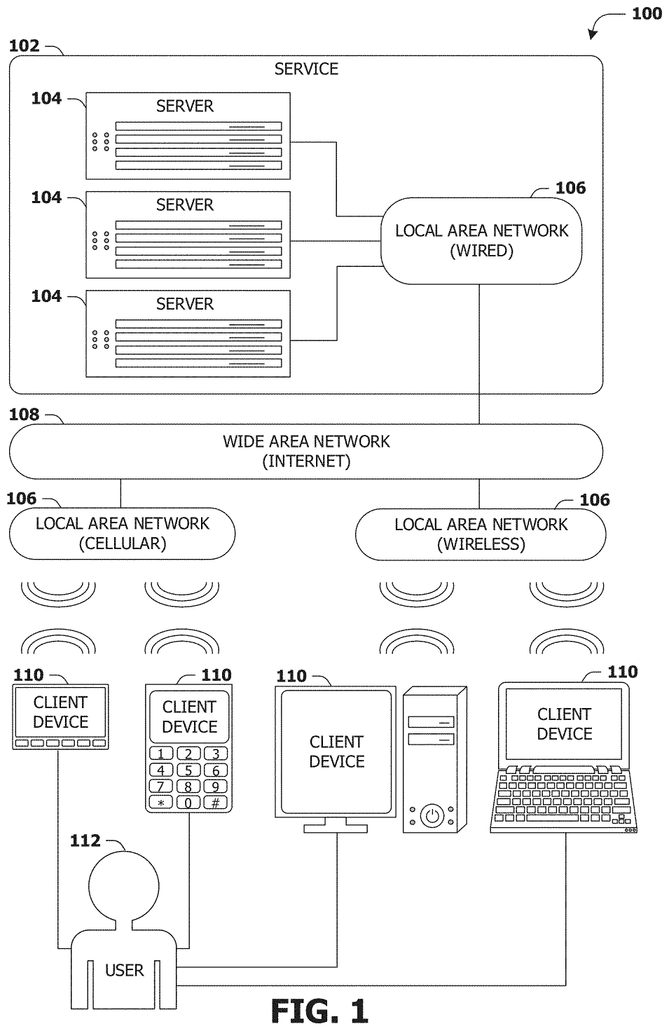

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

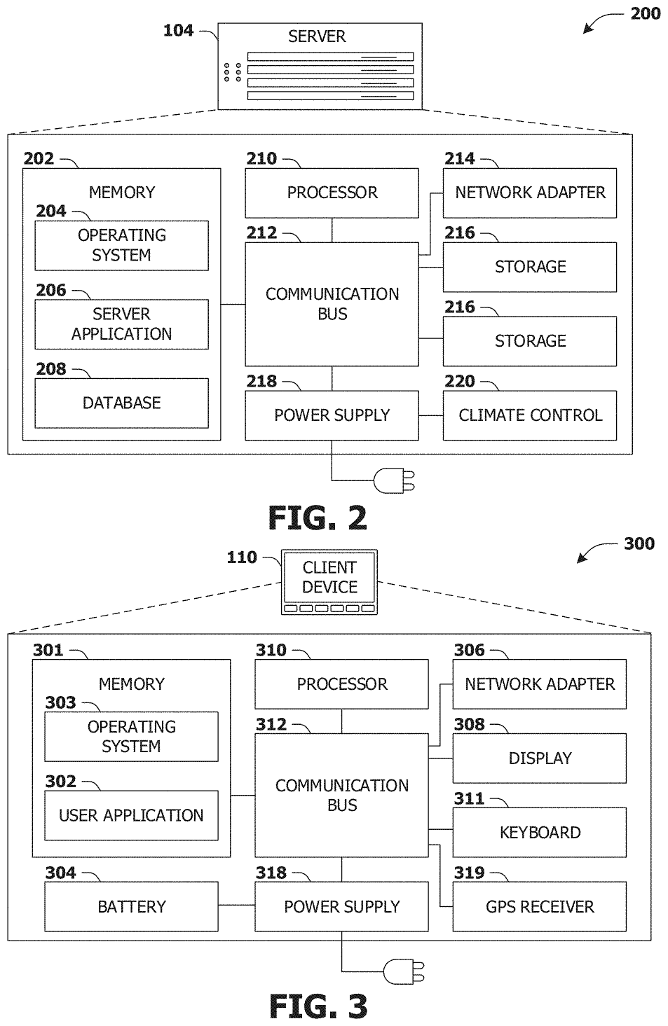

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more computing devices and/or techniques for tagging an object within an image and/or a video with information and/or later detecting the object and retrieving the information are provided. In some examples, a camera, such as a smartphone camera, a camera of a wearable device (e.g., a smart glasses computer comprising a camera, a headset comprising a camera, a smart watch comprising a camera, etc.), a standalone camera (e.g., a security camera), etc. may capture one or more images and/or may record a real-time video and/or transmit the one or more images and/or the real-time video to a client device (e.g., a laptop, a smartphone, a wearable device, etc.). In some examples, there may be an object (e.g., a person, a shirt, a tree, etc.) within the one or more images and/or the real-time video that a user associated with the camera wants to tag with information and/or be reminded of the information a next time that the camera has a view of the object and/or captures an image of the object.

Thus, in accordance with one or more of the techniques presented herein, a first image captured via the camera may be received. For example, the first image may correspond to a portion (e.g., a video frame) of a first real-time video that is continuously transmitted by the camera (and/or a communication module of the camera) to the client device. The first image may be analyzed to identify a first object within the first image. The client device may display a notification that the first object is detected. A request to tag the first object may be received via the device and/or an object tag comprising information associated with the first object may be generated. The object tag may be generated based upon user-inputted information. The object tag and/or object information associated with the first object may be stored (e.g., the object tag and/or the object information may be stored in a user profile associated with a user account of the user).

A second image captured via the camera (and/or a different camera) may be received. For example, the second image may correspond to a portion (e.g., a video frame) of a second real-time video that is continuously transmitted by the camera (and/or the different camera) to the client device (e.g., the second image may be captured and/or received after the first image is captured and/or received and/or after the object tag is generated). The first object may be detected and/or identified within the second image based upon the second image (and/or the second real-time video) and/or the object information. A representation of the object tag may be displayed via a display device of the first client device (e.g., a laptop screen of a laptop, a phone screen of a smartphone, a display of a smart glasses computer, a display of a smart watch, etc.). Alternatively and/or additionally, a location of the first object may be determined based upon the second image. Alternatively and/or additionally, an audio message indicative of the object tag may be output via a speaker of the client device (e.g., the audio message may be output via a speaker within the client device, headphones connected to the client device, a Bluetooth speaker connected to the first client device, etc.).

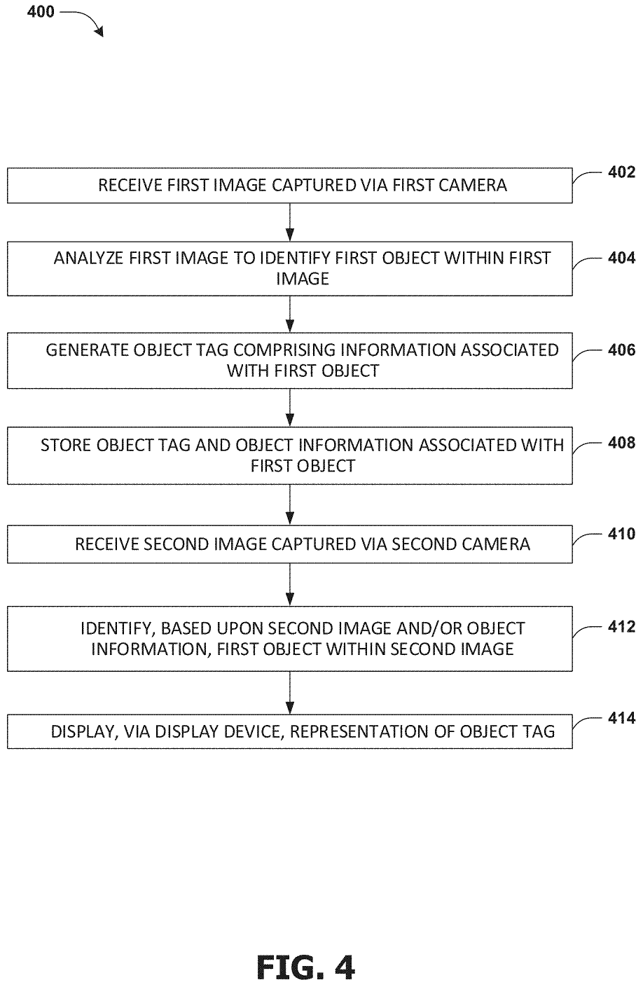

An embodiment of tagging an object within an image and/or a video with information and/or later detecting the object and retrieving the information is illustrated by an example method 400 of FIG. 4. At 402, a first image captured via a first camera may be received. For example, the first image may be received by a first client device (e.g., a laptop, a smartphone, a wearable device, etc.). The first client device may comprise the first camera (e.g., the first camera may be mounted on and/or embedded in the laptop, the smartphone and/or the wearable device). Alternatively and/or additionally, the first camera may be a standalone camera (e.g., the first camera may be a security camera and/or a different type of camera, such as a webcam and/or an external camera, that is not mounted on the first client device). The first camera may be connected to the first client device via a wired connection. Alternatively and/or additionally, the first camera may be connected to the first client device via a wireless connection.

In some examples, the first image may be captured via the first camera responsive to the first camera being activated and/or receiving an image capture request to capture the first image. For example, the first image may be captured responsive to receiving a selection of an image capture selectable input corresponding to the image capture request. The selection of the image capture selectable input may be received via a camera interface of the first client device. Alternatively and/or additionally, the image capture request may be received responsive to a selection of an image capture button, corresponding to capturing an image, on the first camera. Alternatively and/or additionally, the image capture request may be received via one or more of a conversational interface (e.g., a voice recognition and natural language interface) of the first client device where a voice command indicative of the image capture request may be received via a microphone of the first client device, a touchscreen of the first client device, one or more buttons of the first client device, etc.

In some examples, the first image may correspond to a portion of a first real-time video that is continuously recorded and/or continuously transmitted by the first camera to the first client device (e.g., the first real-time video may be continuously transmitted by the first camera using a communication module of the first camera). For example, the first image may correspond to a video frame of the first real-time video. In some examples, the first real-time video may comprise a real-time representation of a view of the first camera. In some examples, the first real-time video may be recorded responsive to the first camera being activated and/or receiving a record request to start recording the first real-time video. For example, the first real-time video may be recorded responsive to receiving a selection of a record selectable input corresponding to the record request. The selection of the record selectable input may be received via the camera interface of the first client device. Alternatively and/or additionally, the record request may be received responsive to a selection of a record button, corresponding to recording a video, on the first camera. Alternatively and/or additionally, the record request may be received via one or more of the conversational interface of the first client device where a voice command indicative of the record request may be received via the microphone of the first client device, the touchscreen of the first client device, one or more buttons of the first client device, etc.

Alternatively and/or additionally, the first image may be captured and/or the first real-time video may be recorded responsive to the camera interface being opened. Alternatively and/or additionally, the first image may be captured and/or the first real-time video may be recorded (automatically) if the first camera is activated and/or if one or more tagging functions are enabled and/or activated. In some examples, the one or more tagging functions may correspond to automatically recording video and/or automatically identifying objects within the video. The one or more tagging functions may be enabled via a settings interface of the first client device. For example, real-time videos (e.g., the first real-time video) may be continuously recorded and/or analyzed for detection and/or identification of objects when the one or more tagging functions are enabled and/or activated.

At 404, the first image may be analyzed to identify a first object within the first image. In some examples, the first image and/or the first real-time video may be analyzed for detection and/or identification of one or more objects responsive to receiving an object detection request corresponding to analyzing the first image and/or the first real-time video to identify one or more objects within the first image. For example, the object detection request may be received via a selection of an object detection selectable input via the first client device. The selection of the object detection selectable input may be received via the camera interface of the first client device. Alternatively and/or additionally, the object detection request may be received responsive to a selection of an object detection button, corresponding to analyzing the first image and/or the first real-time video for detection of one or more objects, on the first camera and/or the first client device. Alternatively and/or additionally, the object detection request may be received via one or more of the conversational interface of the first client device where a voice command indicative of the object detection request may be received via the microphone of the first client device, the touchscreen of the first client device, one or more buttons of the first client device, etc.

Alternatively and/or additionally, the first image and/or the first real-time video may be analyzed for detection of one or more objects automatically responsive to determining that the first camera is active, responsive to determining that the first image is captured and/or responsive to receiving the first image. Alternatively and/or additionally, the first image and/or the first real-time video may be analyzed for detection of one or more objects automatically responsive to determining that the first camera is active, responsive to determining that the first real-time video is being recorded and/or responsive to receiving at least a portion of the first real-time video.

In some examples, a first set of objects (e.g., a set of one or more objects), comprising the first object, may be identified and/or detected within the first image (e.g., within one or more video frames of the first real-time video) by performing one or more image processing techniques and/or one or more computer vision techniques on the first image. For example, the first image (and/or one or more video frames of the first real-time video) may be analyzed using one or more object detection techniques (and/or one or more object segmentation techniques) to detect the first set of objects. Alternatively and/or additionally, the first image may be analyzed using one or more machine learning techniques to detect the first set of objects. For example, the first set of objects may correspond to one or more of one or more moving objects, one or more people, one or more balls, one or more sports players, one or more bicycles, one or more trees, one or more items in a store (e.g., a clothing item in a clothing store), etc.

In some examples, the first image (and/or one or more video frames of the first real-time video) may be analyzed to detect the first set of objects based upon one or more object settings. For example, the one or more object settings may be indicative of one or more types of objects to detect (and/or to include in the first set of objects) (e.g., object categories). For example, the one or more object settings may be indicative of one or more types of objects, such as one or more of a person, a clothing item, a natural object (e.g., a tree, a hill, a river, etc.), a bicycle, a real-world object, a cup, food, a landscape, a street sign, a street, a building, a lamp post, etc.

In some examples, the one or more object settings may be determined based upon a context of the first image and/or the first real-time video. The context of the first image and/or the first real-time video may correspond to one or more of an outdoors image and/or video (e.g., the first image and/or the first real-time video may be captured and/or recorded outdoors), a city image and/or video (e.g., the first image and/or the first real-time video may be captured and/or recorded outdoors within a city, with buildings, streets, and/or other indicators of a metropolitan and/or urban area), a nature image and/or video (e.g., the first image and/or the first real-time video may be captured and/or recorded outdoors within an area with trees, a body of water, and/or other indicators of a nature area), an indoors image and/or video (e.g., the first image and/or the first real-time video may be captured and/or recorded indoors), a shopping center image and/or video (e.g., the first image and/or the first real-time video may be captured and/or recorded in an area with clothing items, athletic items, price tags, products for sale, shelves, store-fronts and/or other indicators of a shopping center), a social gathering image and/or video (e.g., the first image and/or the first real-time video may be captured and/or recorded in an area with people, a speaker on a podium, audience members, and/or other indicators of a social gathering, such as a conference, a meeting, etc.), etc.

In some examples, the context of the first image and/or the first real-time video may be determined by analyzing the first image and/or the first real-time video (e.g., if one or more trees are detected within the first image and/or the first real-time video and/or a building is not detected within the first image and/or the first real-time video, it may be determined that the context of the first image and/or the first real-time video corresponds to a nature image and/or video.

In an example where the context of the first image and/or the first real-time video corresponds to a nature image and/or video, the one or more types of objects to be detected (and/or to be included in the first set of objects if detected) may correspond to one or more of a tree, a mountain, a body of water, a dock, a flower, an animal, a trail, a sign, etc.

In an example where the context of the first image and/or the first real-time video correspond to an indoors image and/or video, the one or more types of objects to be detected (and/or to be included in the first set of objects if detected) may correspond to one or more of a rug, a painting, a table, a chair, etc.

In an example where the context of the first image and/or the first real-time video correspond to a shopping center image and/or video, the one or more types of objects to be detected (and/or to be included in the first set of objects if detected) may correspond to one or more of a person, a clothing item, an athletic item, a product for sale, etc.

In an example where the context of the first image and/or the first real-time video correspond to a social gathering image and/or video, the one or more types of objects to be detected (and/or to be included in the first set of objects if detected) may correspond to a person, for example.

Alternatively and/or additionally, the one or more object settings and/or the context of the first image and/or the first real-time video may be determined based upon one or more settings inputs. For example, the one or more settings inputs may be indicative of the one or more types of objects to be detected (and/or to be included in the first set of objects if detected) and/or the context of the first image and/or the first real-time video. In some examples, the one or more settings inputs may be received via the settings interface of the first client device (e.g., the settings interface may be associated with the camera interface of the first client device). Alternatively and/or additionally, the one or more settings inputs may be received via the conversational interface of the first client device where a voice command indicative of the context of the first image and/or the first real-time video and/or the one or more types of objects to be detected (and/or to be included in the first set of objects if detected) may be received via the microphone of the first client device.

Alternatively and/or additionally, the first image (and/or one or more video frames of the first real-time video) may be analyzed to detect the first set of objects based upon one or more object datasets. For example, an object dataset of the one or more object datasets may correspond to a type of object of the one or more types of objects. An object dataset may comprise information associated with a type of object, such as an appearance of objects corresponding to the type of object, one or more parameters associated with objects corresponding to the type of object, colors associated with objects corresponding to the type of object, measurements associated with objects corresponding to the type of object, etc.

In some examples, the first set of objects may be identified and/or detected using one or more object segmentation techniques and/or one or more image segmentation techniques. For example, the first image may be segmented into multiple segments using the one or more object segmentation techniques and/or the one or more image segmentation techniques. The first image may be segmented into the multiple segments based upon one or more of color differences between portions of the first image, detected boundaries associated with the multiple segments, etc. In some examples, a segment of the multiple segments may be analyzed to determine an object associated with the segment. For example, an object of the first set of objects may be detected by comparing a segment of the multiple segments with the one or more object datasets to determine whether the segment matches a type of object of the one or more object datasets. In some examples, the one or more object datasets may be retrieved from an object information database. For example, the object information database may be analyzed based upon the one or more object settings and/or the context of the first image and/or the first real-time video to identify the one or more object datasets and/or retrieve the one or more object datasets from the object information database.

In some examples, responsive to identifying and/or detecting the first set of objects, the first client device may output a display notification via a display device of the first client device. Alternatively and/or additionally, responsive to identifying and/or detecting the first set of objects, the first client device may output an audio notification via a speaker of the first client device. The display notification and/or the audio notification may be indicative of the first set of objects being detected. For example, a first augmented image of the first image may be generated. The first augmented image of the first image may comprise at least a portion of the first image comprising the first set of objects and/or a first set of indicators (e.g., a set of one or more indicators) associated with the first set of objects.

A first indicator of the first set of indicators may be associated with the first object. The first indicator may be overlaid onto a region of the first image (and/or a region of the first real-time video) comprising the first object. Alternatively and/or additionally, the first indicator may be overlaid onto a region of the first image (and/or a region of the first real-time video) adjacent to the first object. The first indicator may comprise a graphical object (e.g., one or more of a symbol, a picture, an arrow, a star, a circle, etc.) identifying the first object. Alternatively and/or additionally, the first indicator may be indicative of the first object being detected. Alternatively and/or additionally, the first indicator may comprise text indicative of a first type of object of the first object. For example, if the first object is a tree, the first indicator may comprise “tree”.

At 406, a first object tag comprising first information associated with the first object may be generated. In some examples, the first object tag may be generated responsive to receiving a request to generate the first object tag. For example, a selection of the first indicator associated with the first object may correspond to the request to generate the first object tag (e.g., the request to generate the first object tag may be received via the selection of the first indicator). Alternatively and/or additionally, the request to generate the first object tag may be received via one or more of the conversational interface of the first client device where a voice command indicative of the request to generate the first object tag may be received via the microphone of the first client device, the touchscreen of the first client device, one or more buttons of the first client device, etc.

In some examples, the first object tag may be generated based upon user-inputted information. For example, a tag interface may be displayed via the first client device. The tag interface may display a message instructing the user associated with the first client device to provide the first information. For example, a text-input (e.g., “beautiful tree”) may be input via a keyboard (e.g., a touchscreen keyboard and/or a physical keyboard) of the first client device. The text-input may be received via the tag interface. The first object tag (e.g., “beautiful tree”) may be generated based upon the text-input.

Alternatively and/or additionally, an audio recording (e.g., a voice command) comprising speech may be received via the microphone of the first client device. For example, the audio recording may comprise the user saying “beautiful tree”. The audio recording may be transcribed (e.g., using one or more voice recognition and/or transcription techniques) to generate a transcription (e.g., “beautiful tree”). The first object tag may be generated based upon the transcription and/or the audio recording.

Alternatively and/or additionally, the request to generate the first object tag may be received via receiving the audio recording used to generate the first object tag. For example, the audio recording may comprise the user saying “tag the tree as beautiful tree”. The audio recording may be transcribed (e.g., using one or more voice recognition and/or transcription techniques) to generate the transcription (e.g., “tag the tree as beautiful tree”). The audio recording may serve as the request to generate the first object tag. The first set of objects may be analyzed to identify an object of the first set of objects that is a type of object corresponding to “tree”. For example, the first object may be identified from the first set of objects based upon the audio recording and/or the transcription (e.g., it may be determined that the first object is the type of object corresponding to “tree”). The first object tag (e.g., “beautiful tree”) may be generated based upon the transcription and/or the audio recording.

In some examples, the first object tag may be generated automatically. For example, the first object tag may be generated responsive to determining that the first object is within the first real-time video (and/or within view of the first camera) for a threshold duration of time. Alternatively and/or additionally, the first object tag may be generated based upon visual characteristics of the first object and/or the type of object of the first object. In an example where the first object is a couch, the couch is blue and/or the couch is large compared with other couches, the first object tag may be generated comprising “Big blue couch”. In an example where the first object is a person and/or a nametag comprising “Joe Hedge” is worn by and/or attached to the person, the first object tag may be generated comprising “Joe Hedge”.

At 408, the first object tag and/or object information associated with the first object may be stored. For example, the first object tag and/or the object information may be stored in device memory of the first client device. Alternatively and/or additionally, the first object tag and/or the object information may be stored in a server. For example, the first object tag and/or the object information may be stored in a first user profile associated with a first user account associated with the user and/or the first client device.

In some examples, the object information may comprise visual information associated with the first object. For example, the object information may comprise the type of object of the first object. Alternatively and/or additionally, the object information may comprise the first image. Alternatively and/or additionally, the object information may comprise one or more images, different than the first image, comprising the first object (e.g., the one or more images may correspond to one or more video frames of the first real-time video comprising the first object). Alternatively and/or additionally, the object information may comprise merely a first portion of the first image corresponding to the first object (e.g., the first portion of the first image may comprise the first object). Alternatively and/or additionally, the object information may comprise one or more visual characteristics associated with the first object such as one or more of an appearance of the first object, one or more parameters of the first object, one or more colors of the first object, one or more measurements (e.g., size measurements, depth measurements, width measurements, etc.) of the first object, etc.

Alternatively and/or additionally, the object information associated with the first object may comprise a first location associated with the first object. For example, the first location may correspond to a device location of the first client device and/or the first camera when the first image is captured and/or received (and/or when the first real-time video is recorded and/or received). For example, the device location may comprise a first set of coordinates associated with the first client device and/or the first camera. For example, the first set of coordinates may comprise a first longitude coordinate of the first client device and/or the first camera and/or a first latitude coordinate of the first client device and/or the first camera. In some examples, the device location may be determined based upon location information associated with the first client device and/or the first camera.

The location information may be received from a wireless network (e.g., a WiFi network, a hotspot, a wireless access point (WAP), a network associated with a base station, etc.) that the first client device is connected to. For example, the location information may comprise received signal strength indicators (RSSIs) associated with communications between the first client device and the wireless network. Alternatively and/or additionally, the location information may comprise angle of arrival (AoA) information. One or more RSSI localization techniques and/or one or more trilateration techniques may be performed using the RSSIs and/or the AoA information to determine the device location of the first client device.

Alternatively and/or additionally, the location information may comprise satellite navigation information comprising longitude measurements, latitude measurements and/or altitude measurements associated with locations of the first client device. The satellite navigation information may be received from a satellite navigation system, such as a global navigation satellite system (GNSS) (e.g., Global Positioning System (GPS), Global Navigation Satellite System (GLONASS), Galileo, etc.). In some examples, the device location of the first client device (and/or the user) may be determined based upon merely the satellite navigation information. Alternatively and/or additionally, the device location may be determined based upon a combination of the satellite navigation information, the AoA information and/or the RSSIs.

Alternatively and/or additionally, the first location may correspond to an object location of the first object (when the first image is captured and/or received). The first location may be determined based upon the device location, the first image and/or one or more video frames of the first real-time video comprising the first object. For example, the first image may be analyzed to determine a distance between the device location and the first object. The distance may be combined with the device location to determine the first location of the first object. Alternatively and/or additionally, the first image (and/or one or more video frames of the first real-time video) may be analyzed using one or more image recognition techniques and/or one or more object recognition techniques to identify one or more landmarks within the first image (e.g., the first image and/or the one or more video frames of the first real-time video may be compared with a landmark information database to identify the one or more landmarks within the first image). The one or more landmarks may correspond to one or more of one or more structures, one or more buildings, one or more natural locations, etc. One or more locations of the one or more landmarks may be determined. The first location may be determined based upon the one or more locations.

Alternatively and/or additionally, the object information associated with the first object may comprise audio information (e.g., sound information, voice information, etc.) associated with the first object and/or the first image (and/or the first real-time video). For example, the object information may comprise a second audio recording recorded via the microphone during a time that the first image is captured (and/or during a time that the first real-time video is recorded). In an example where the first object corresponds to a person, the second audio recording may comprise the person speaking. For example, one or more voice characteristics associated with the person may be determined based upon the second audio recording. The object information may comprise the one or more voice characteristics and/or the second audio recording.

At 410, a second image captured via a second camera may be received. In some examples, the second camera may be the same as the first camera. Alternatively and/or additionally, the second camera may be different than the first camera. In some examples, the second image may be received by the first client device. In some examples, the second image may correspond to a portion of a second real-time video that is continuously recorded and/or continuously transmitted by the second camera to the first client device. For example, the second image may correspond to a video frame of the second real-time video. In some examples, the second real-time video may be recorded responsive to the second camera being activated and/or receiving a record request to start recording the second real-time video.

At 412, the first object may be identified within the second image based upon the second image and/or the object information. For example, the second image may be analyzed based upon the object information associated with the first object to determine that the second image comprises the first object. The second image may be analyzed using one or more object recognition techniques to determine that the second image comprises the first object.

In some examples, the second image may be captured and/or the second real-time video may be recorded responsive to receiving a second image capture request and/or receiving a second record request (via the first client device). Alternatively and/or additionally, the second real-time video (comprising the second image) may be recorded automatically and/or continuously. Alternatively and/or additionally, the second real-time video (and/or video frames of the second real-time video) may be monitored and/or analyzed (continuously) based upon the object information for detecting and/or identifying the first object. Alternatively and/or additionally, the first camera may automatically capture images at an image capture rate (e.g., 3 images per minute, 20 images per minute, etc.) and/or captured images may be monitored and/or analyzed (continuously) based upon the object information for detecting and/or identifying the first object within one or more images of the captured images (e.g., the one or more images may comprise the second image).

In some examples, an object within the second image may be detected and/or identified. In some examples, the object may be analyzed based upon the object information associated with the first object to determine whether the object is the same as the first object. The object may be analyzed based upon the object information associated with the first object responsive to a determination that the object is the type of object of the first object.

For example, one or more second visual characteristics of the object (e.g., one or more of an appearance of the object, one or more parameters of the object, one or more colors of the object, one or more measurements of the object, etc.) may be compared with the one or more visual characteristics associated with the first object to determine a similarity between the object of the second image and the first object. Alternatively and/or additionally, the second image and/or a second portion of the second image comprising the object may be compared with the first image, the one or more images comprising the first object (within the object information) and/or the first portion of the first image to determine the similarity between the object of the second image and the first object. Responsive to a determination that the similarity does not meet a threshold similarity, it may be determined that the object is not the same as the first object. Alternatively and/or additionally, responsive to a determination that the similarity meets the threshold similarity, it may be determined that the object is the same as the first object and/or the first object may be identified within the second image and/or within the second real-time video.

Alternatively and/or additionally, a second location associated with the second image may be determined. For example, the second location may correspond to a second device location of the first client device and/or the second camera when the second image is captured and/or received (and/or when the second real-time video is recorded and/or received). Alternatively and/or additionally, the second location may correspond to a second object location of the object of the second image (when the second image is captured and/or received). The second location may be determined based upon the second device location, the second image and/or one or more video frames of the second real-time video comprising the object (of the second image). Alternatively and/or additionally, the second image (and/or one or more video frames of the second real-time video) may be analyzed using one or more image recognition techniques to identify one or more second landmarks within the first image. One or more locations of the one or more second landmarks may be determined. The second location may be determined based upon the one or more locations of the one or more second landmarks.

In some examples, a distance between the first location (associated with the first object) and the second location (associated with the object of the second image) may be determined. For example, the first location may be compared with the second location to determine the distance. In some examples, responsive to a determination that the distance is greater than a threshold distance, it may be determined that the object is not the same as the first object. Alternatively and/or additionally, responsive to a determination that the distance is less than the threshold distance, it may be determined that the object is the same as the first object and/or the first object may be identified within the second image.

In some examples, the threshold distance may be configured based upon the type of object of the first object and/or the object of the second image. In an example where the first type of object is a moving object (e.g., a person, a car, an animal, etc.) the threshold distance may be higher than in an example where the first type of object that does not move (e.g., a tree, a building, etc.).

Alternatively and/or additionally, a third audio recording may be recorded via the microphone during a time that the second image is captured (and/or during a time that the second real-time video is recorded). In an example where the first object is a person, one or more second voice characteristics may be determined based upon the third audio recording (e.g., the third audio recording may comprise the person speaking). In some examples, the third audio recording and/or the one or more second voice characteristics may be compared with the second audio recording (of the object information) and/or the one or more voice characteristics (of the object information) to determine an audio similarity (e.g., a voice similarity) between the third audio recording and the second audio recording. In some examples, responsive to a determination that the audio similarity does not meet a threshold audio similarity, it may be determined that the object is not the same as the first object. Alternatively and/or additionally, responsive to a determination that the audio similarity meets the threshold audio similarity, it may be determined that the object is the same as the first object and/or the first object may be identified within the second image.

At 414, a representation of the first object tag may be displayed via the display device of the first client device. For example, the representation of the first object tag may be displayed via the display device of the first client device responsive to identifying the first object within the second image (and/or within the second real-time video). In some examples, the second image may be modified based upon the first object tag to generate a modified image. The modified image may be generated responsive to identifying the first object within the second image. The modified image may comprise at least a portion of the second image comprising the first object. Alternatively and/or additionally, the modified image may comprise the representation of the first object tag. The representation of the first object tag may be overlaid onto the modified image. In some examples, the representation of the first object tag may comprise a graphical object comprising the first object tag. The modified image comprising the representation of the first object tag and/or the first object may be displayed via the display device of the first client device.

In an example where the first object is a tree and/or the first object tag comprises “beautiful tree”, the representation of the first object tag may comprise “beautiful tree” and/or the representation of the first object tag may be displayed over (e.g., overlaying) the tree and/or adjacent to the tree within the modified image. Alternatively and/or additionally, the representation of the first object tag may be displayed in a corner of the modified image and/or in a different location of the modified image.

Alternatively and/or additionally, the representation of the first object tag may be overlaid onto the second real-time video. For example, the representation of the first object tag may be overlaid onto the second real-time video responsive to identifying the first object within the second image (and/or within the second real-time video). Alternatively and/or additionally, the second real-time video (e.g., a real-time view of the first camera and/or the second camera) may be displayed, as well as the representation of the first object tag, overlaid onto the second real-time video. In some examples, the second real-time video may be overlaid onto the second real-time video using one or more augmented reality (AR) techniques. Alternatively and/or additionally, the representation of the first object tag may be displayed adjacent to the second real-time video. For example, the representation of the first object tag may be displayed adjacent to the second real-time video responsive to identifying the first object within the second image (and/or within the second real-time video).

In an example where the first object is a tree, the first object tag comprises “beautiful tree” and/or the representation of the first object tag comprises “beautiful tree”, the representation of the first object tag may be displayed over (e.g., overlaying) the tree and/or adjacent to the tree within the second real-time video. Alternatively and/or additionally, the representation of the first object tag may be displayed over a corner of the second real-time video and/or over a different location of the second real-time video.

Alternatively and/or additionally, an audio message, indicative of the first object tag, may be output via the speaker of the first client device. For example, the audio message may be output via the speaker (e.g., a phone speaker, a pair of headphones connected to the first client device, a Bluetooth speaker connected to the first client device, etc.) of the first client device responsive to identifying the first object within the second image (and/or within the second real-time video). For example, the audio message may comprise speech comprising (and/or representative of) the first object tag. Alternatively and/or additionally, the audio message may comprise speech comprising (and/or representative of) a modified version of the first object tag.

In an example where the first object is a tree and/or the first object tag comprises “beautiful tree”, the audio message may comprise the speech comprising “beautiful tree”.

Alternatively and/or additionally, merely the representation of the first object tag may be displayed using the display device (and/or a different display device). For example, a notification, comprising the representation of the first object tag, may be displayed by the display device. In some examples, the display device may correspond a laptop screen of a laptop, a phone screen of a smartphone, a computer monitor, a display of a car (e.g., a head-up display (HUD) of the car) and/or a display of a smart glasses computer (e.g., an HUD of the smart glasses computer).

In some examples, one or more of the techniques presented herein may be performed using a combination of multiple client devices. For example, the first client device may operate in association with one or more client devices and/or one or more servers to perform operations associated with the techniques presented herein.

In an example scenario, the first client device may be connected to a second client device comprising the first camera. For example, the first client device may be wirelessly connected to the second client device and/or the first camera (e.g., the first client device may be wirelessly connected to the second client device and/or the first camera via a Bluetooth connection and/or a different type of wireless connection). The second client device may correspond to a wearable device, such as a smart glasses computer, and/or the first camera may correspond to a camera of the smart glasses computer.

In some examples, the first camera may be mounted to and/or embedded within the second client device. The first camera may be activated responsive to receiving the image capture request and/or the record request. For example, the image capture request and/or the record request may be received via the second client device (e.g., one or more of via a button of the second client device, via a conversational interface of the second client device, etc.) and/or the first client device. Alternatively and/or additionally, the first camera may be activated automatically. In some examples, the first image, the first real-time video and/or the first set of indicators (associated with the first set of objects) may be displayed via the display device of the first client device (and/or via a second display device of the second client device). Alternatively and/or additionally, the request to generate the first object tag associated with the first object tag may be received via the first client device (and/or via the second client device).

In some examples, the second image may be captured and/or the second real-time video may be recorded via the first camera (and/or the second camera). In some examples, responsive to identifying the first object within the second image and/or the second real-time video, the representation of the first object tag may be displayed via the display device of the first client device and/or via the second display device of the second client device. For example, the representation of the first object tag may be displayed via an HUD of the second client device (such that the user may view both the representation of the first object tag via the HUD and the first object).

In some examples, the first object tag may be shared with one or more (other) client devices (e.g., the first object tag may be shared via email, messaging, etc.). For example, a sharing interface may be displayed via the first client device (and/or the second client device). The first object tag and/or the object information associated with the first object may be transmitted to a third client device (via email, messaging, social media, etc.) responsive to receiving a request to share the first object tag. For example, a third image and/or a third real-time video captured via the third client device may be analyzed based upon the object information to identify the first object within the third image and/or the third real-time video. In some examples, responsive to identifying the first object within the third image, the third client device may display a second representation of the first object tag. Alternatively and/or additionally, responsive to identifying the first object within the third image, the third client device may output a second audio message, indicative of the first object tag.

In some examples, the techniques presented herein may be performed in a variety of applications. In an exemplary application of the presented techniques, one or more of the techniques of the present disclosure may be used in the service industry. For example, the first client device and/or the second client device may be used by a server of a restaurant. The first image may be captured and/or the first real-time video may be recorded while the server takes one or more orders from one or more customers. The first object may correspond to a customer of the one or more customers.

The first object tag may correspond to an order (e.g., a food order) of the customer (e.g., the first object tag may comprise “burger without mushrooms with orange soda”). Alternatively and/or additionally, the object information and/or the first object tag may be stored. When the server retrieves food corresponding to the order and approaches the customer, the customer may be in view of the first camera (e.g., the first camera may be positioned on the server, such as using a smart glasses computer). For example, the second image comprising the customer may be captured and/or the second real-time video comprising the customer may be recorded. The customer may be detected and/or identified within the second image and/or the second real-time video based upon the object information (e.g., one or more visual characteristics associated with the customer) and/or using one or more facial recognition techniques. Responsive to identifying the customer within the second image and/or the second real-time video, the display device may display the representation of the first object tag (e.g., the display device may be an HUD of the smart glasses computer). The server may be certain, based upon the representation of the first object tag, that the food corresponds to the order of the customer. Thus, the server may provide the customer with the food.

In an exemplary application of the presented techniques, one or more of the techniques of the present disclosure may be used for automating parts of the service industry. For example, the customer may place the order using an ordering interface of a computer (e.g., one or more of a laptop, a tablet, a different type of computer, etc.). The first camera may be positioned such that the customer placing the order is in view of the first camera. In some examples, the first real-time video (comprising the customer) may be recorded while the order is being placed via the ordering interface. Alternatively and/or additionally, responsive to receiving the order via the ordering interface, the first image may be captured by the first camera. The first object tag may be generated based upon the order (e.g., the first object tag may comprise components of the order). The first image and/or the first real-time video may be analyzed to generate the object information.

The customer may be seated in the restaurant. The second camera (and/or the first camera) may have a view of tables and/or seats of the restaurant. The second real-time video recorded using the second camera and/or the second image captured using the second camera may be analyzed to identify the customer within the second real-time video and/or the second image. Responsive to identifying the customer within the second real-time video and/or the second image, the second real-time video and/or the second image may be analyzed to determine a location of the customer. For example, a table where the customer is seated may be determined (e.g., the location of the customer may correspond to the table). Alternatively and/or additionally, a seat where the customer is seated may be determined (e.g., the location of the customer may correspond to the seat). For example, the object tag and/or the location of the customer may be displayed and/or provided to the server to facilitate delivery of the food to the customer. For example, the server may understand where to take the food based upon the object tag and/or the location of the customer.

Alternatively and/or additionally, the location of the customer may be input to an automated delivery system, which may deliver the food, associated with the order and/or the first object tag, to the customer based upon the location. For example, the automated delivery system may comprise a tunnel, associated with the location of the customer, of a plurality of tunnels, through which the food is delivered to the customer. For example, the tunnel may be selected from the plurality of tunnels for delivery of the food to the customer based upon the location of the customer (e.g., the customer may be seated closer to the tunnel than other tunnels of the plurality of tunnels). Accordingly, the food may be delivered through the tunnel to the customer.

In some examples, when using techniques of the present disclosure in the service industry (and/or for other applications, such as applications in public settings), privacy-sensitive information may be deleted (periodically). Alternatively and/or additionally, the object information and/or the first object tag may be deleted after a threshold duration of time has passed since the object information and/or the first object tag was generated. Alternatively and/or additionally, the first image, the first real-time video, the second image and/or the second real-time video may be deleted after the threshold duration of time has passed.

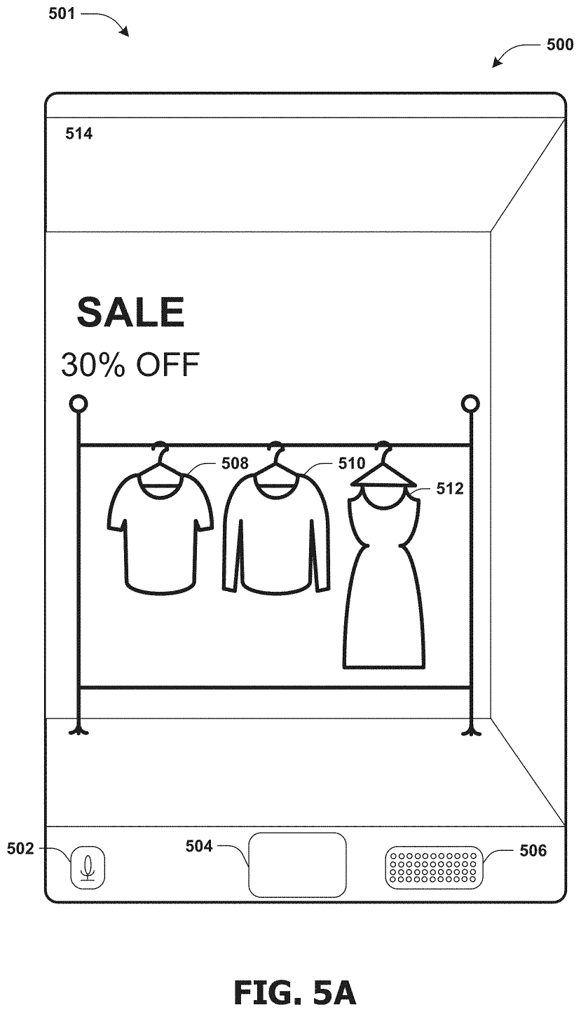

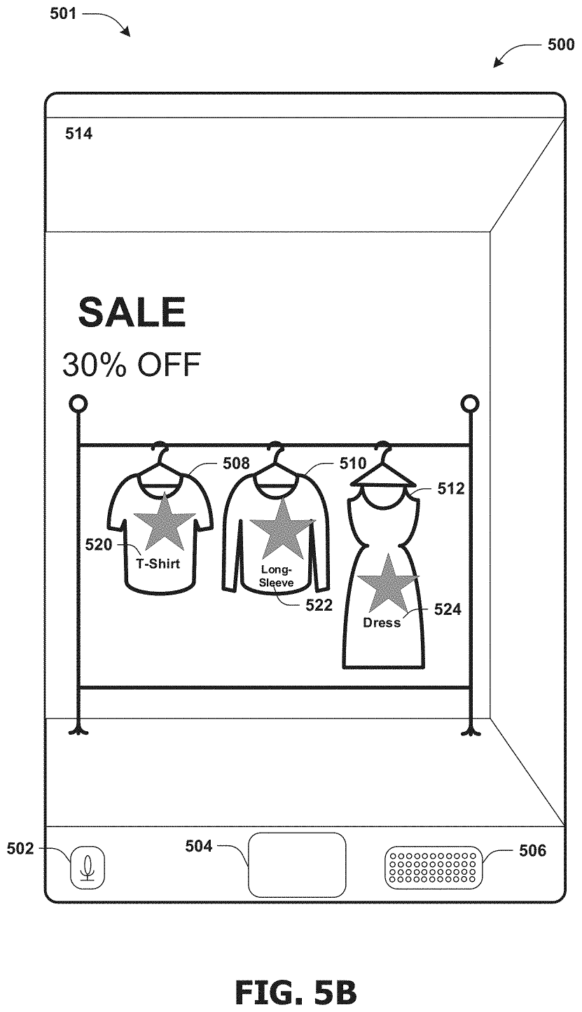

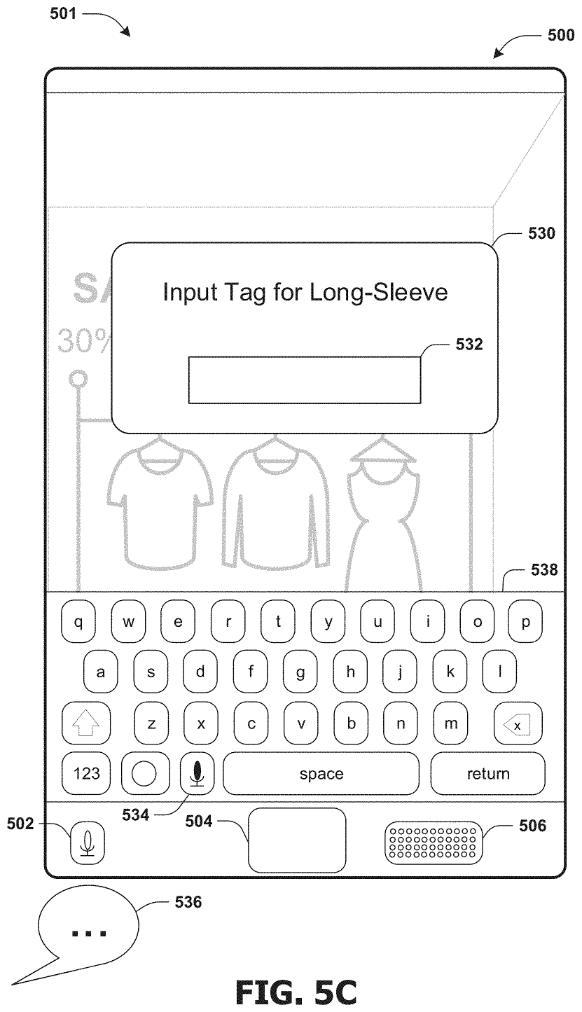

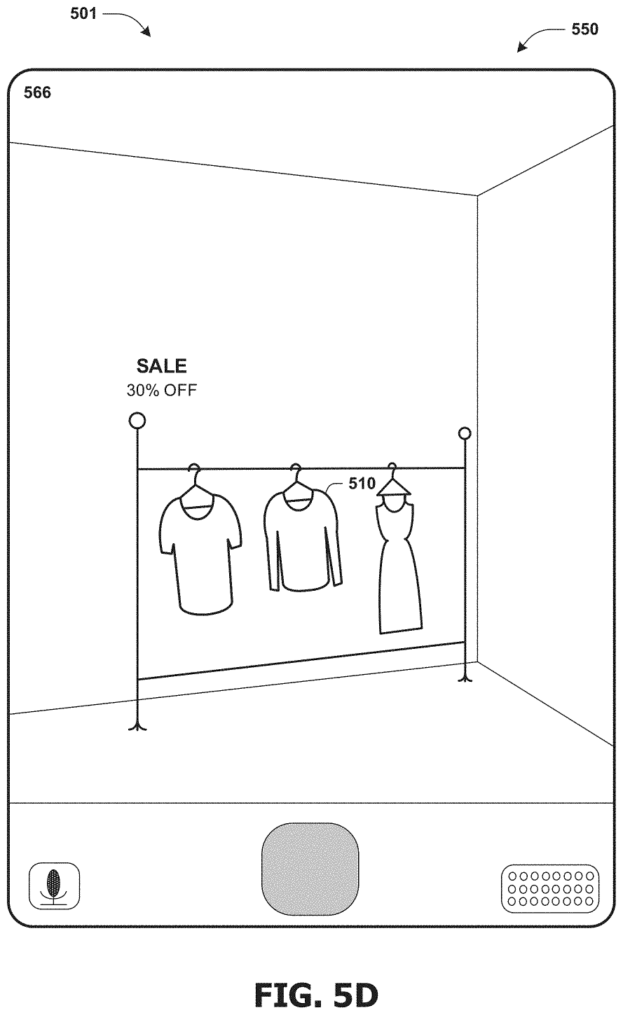

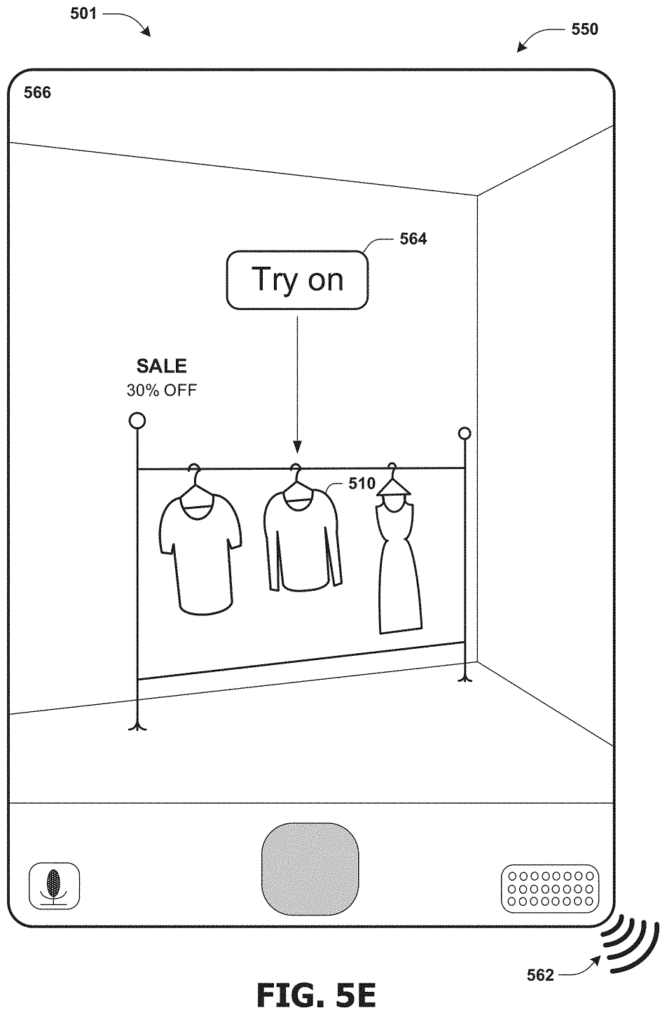

FIGS. 5A-5E illustrate a system 501 for tagging an object within an image and/or a video with information and/or later detecting the object and retrieving the information. A first user, such as user Jay, may use and/or interact with a first client device 500 for tagging objects with information. The first client device 500 may comprise a microphone 502, a button 504 and/or a speaker 506. In some examples, the first user and/or the first client device 500 may be inside of a store (e.g., a clothing store).

FIG. 5A illustrates the first client device 500 displaying a first real-time video 514. The first real-time video 514 may comprise a real-time representation of a view of a first camera. For example, the first real-time video 514 may be continuously recorded and/or continuously transmitted by the first camera (and/or by a communication module of the first camera). In some examples, the first camera may be mounted on and/or embedded within the first client device 500. Alternatively and/or additionally, the first camera may be wirelessly connected to the first client device 500. For example, the first camera may be mounted on and/or embedded within a wearable device, such as a smart glasses computer. In some examples, a first set of objects may be identified and/or detected within the first real-time video 514. For example, the first set of objects may comprise a first object 508 (e.g., a t-shirt), a second object 510 (e.g., a long-sleeve shirt) and/or a third object 512 (e.g., a dress).

FIG. 5B illustrates the first client device 500 displaying a first set of indicators associated with the first set of objects. For example, the first set of indicators may be generated and/or displayed responsive to identifying the first set of objects within the first real-time video 514. In some examples, an indicator of the first set of indicators may comprise a graphical object (e.g., a star-symbol) and/or an indication of a type of object of an object of the first set of objects.

For example, a first indicator 520, of the first set of indicators, associated with the first object 508 may comprise a graphical object and/or an indication of a type of object of the first object 508 (e.g., “T-shirt”). Alternatively and/or additionally, the first indicator 520 may be overlaid onto a region of the first real-time video 514 comprising the first object 508 using one or more AR techniques. Alternatively and/or additionally, the first indicator 520 may be overlaid onto a region of the first real-time video 514 adjacent to the first object 508 using one or more AR techniques.

Alternatively and/or additionally, a second indicator 522, of the first set of indicators, associated with the second object 510 may comprise a graphical object and/or an indication of a type of object of the second object 510 (e.g., “Long-sleeve”). Alternatively and/or additionally, the second indicator 522 may be overlaid onto a region of the first real-time video 514 comprising the second object 510 using one or more AR techniques. Alternatively and/or additionally, the second indicator 522 may be overlaid onto a region of the first real-time video 514 adjacent to the second object 510 using one or more AR techniques.

Alternatively and/or additionally, a third indicator 524, of the first set of indicators, associated with the third object 512 may comprise a graphical object and/or an indication of a type of object of the third object 512 (e.g., “Dress”). Alternatively and/or additionally, the third indicator 524 may be overlaid onto a region of the first real-time video 514 comprising the third object 512 using one or more AR techniques. Alternatively and/or additionally, the third indicator 524 may be overlaid onto a region of the first real-time video 514 adjacent to the third object 512 using one or more AR techniques.

In some examples, a request to generate a first object tag associated with the second object 510 may be received via the first client device 500. For example, the request to generate the first object tag may be received via a selection of the second indicator 522 associated with the second object 510. Alternatively and/or additionally, the request to generate the first object tag may be received via a voice command received via the microphone 502 of the first client device 500.

FIG. 5C illustrates the first client device 500 displaying a tag interface 530. For example, the tag interface 530 may be displayed responsive to receiving the request to generate the first object tag associated with the second object 510. The tag interface 530 may comprise a text-area 532 and/or a message “Input Tag for Long-Sleeve” instructing the first user to input first information associated with the second object 510. For example, the first information may be inputted using a keyboard 538 (e.g., a touchscreen keyboard and/or a physical keyboard). Alternatively and/or additionally, an audio recording 536 comprising speech may be received (from the user) via the microphone 502. For example, the audio recording 536 may comprise the first user saying “try on”. The audio recording 536 may be transcribed (e.g., using one or more voice recognition and/or transcription techniques) to generate a transcription (e.g., “Try on”). The first object tag may be generated based upon the transcription (e.g., the first object tag may comprise “Try on”). In some examples, the audio recording 536 may be received via the microphone 502 responsive to a selection of a conversational interface selectable input 534 of the keyboard 538 corresponding to activating the microphone 502.

In some examples, the first object tag and/or object information associated with the second object 510 may be stored. For example, the first object tag and/or the object information may be stored in device memory of the first client device 500. Alternatively and/or additionally, the first object tag and/or the object information may be stored in a server. For example, the first object tag and/or the object information may be stored in a first user profile associated with a first user account associated with the first user and/or the first client device 500.

In some examples, the object information may comprise visual information associated with the second object 510. For example, the object information may comprise the type of object (e.g., a long-sleeve shirt) of the second object 510. Alternatively and/or additionally, the object information may comprise one or more images comprising the second object 510 (e.g., one or more video frames, of the first real-time video 514, comprising the second object 510). Alternatively and/or additionally, the object information may comprise one or more visual characteristics associated with the second object 510 such as one or more of an appearance of the second object 510, one or more parameters of the second object 510, one or more colors of the second object 510, one or more measurements (e.g., size measurements, depth measurements, width measurements, etc.) of the second object 510, etc. Alternatively and/or additionally, the object information associated with the second object 510 may comprise a first location associated with the second object 510.

In some examples, the first object tag and/or the object information associated with the second object 510 may be transmitted to a second client device 550 (illustrated in FIG. 5D) by the first client device 500. For example, the first object tag and/or the object information associated with the second object 510 may be transmitted to the second client device 550 responsive to receiving a request to share the first object tag. In some examples, the first object tag and/or the object information may be stored in the second client device 550. Alternatively and/or additionally, the second client device 550 may access the first object tag and/or the object information via a connection to a server.

FIG. 5D illustrates the second client device 550 displaying a second real-time video 566. The second real-time video 566 may comprise a real-time representation of a view of a second camera. For example, the second real-time video 566 may be continuously recorded and/or continuously transmitted by the second camera (and/or by a communication module of the second camera).

In some examples, the second object 510 may be identified within the second real-time video 566 based upon the second real-time video 566 and/or the object information associated with the second object 510. For example, the second real-time video 566 (and/or one or more video frames of the second real-time video 566) may be analyzed based upon the object information to determine that the second real-time video 566 (and/or one or more video frames of the second real-time video 566) comprises the second object 510. The second real-time video 566 (and/or one or more video frames of the second real-time video 566) may be analyzed using one or more object recognition techniques to determine that the second real-time video 566 (and/or one or more video frames of the second real-time video 566) comprises the second object 510.

FIG. 5E illustrates the second client device 550 displaying a representation 564 of the first object tag associated with the second object 510. For example, the representation 564 of the first object tag may be displayed responsive to identifying the second object 510 within the second real-time video 566. Alternatively and/or additionally, the representation 564 of the first object tag may be overlaid onto the second real-time video 566 responsive to identifying the second object 510 within the second real-time video 566. In some examples, the representation 564 of the first object tag may be overlaid onto a region of the second real-time video 566 adjacent to the second object 510. Alternatively and/or additionally, the representation 564 of the first object tag may be overlaid onto a region of the second real-time video 566 comprising the second object 510.

Alternatively and/or additionally, the representation 564 of the first object tag may be displayed via a display device (e.g., an HUD). For example, a client device (e.g., a wearable device, such as one or more of a smart glasses computer, a smart watch, etc.) different than the second client device 550 may comprise the display device.

Alternatively and/or additionally, an audio message 562, indicative of the first object tag, may be output via a speaker of the second client device 550. For example, the audio message 562 may be output via the speaker (e.g., a phone speaker, a pair of headphones connected to the second client device 550, a Bluetooth speaker connected to the second client device 550, etc.) of the second client device 550 responsive to identifying the second object 510 within the second real-time video 566. For example, the audio message 562 may comprise speech comprising (and/or representative of) the first object tag (e.g., “Try on”). Alternatively and/or additionally, the audio message 562 may comprise speech comprising (and/or representative of) a modified version of the first object tag.

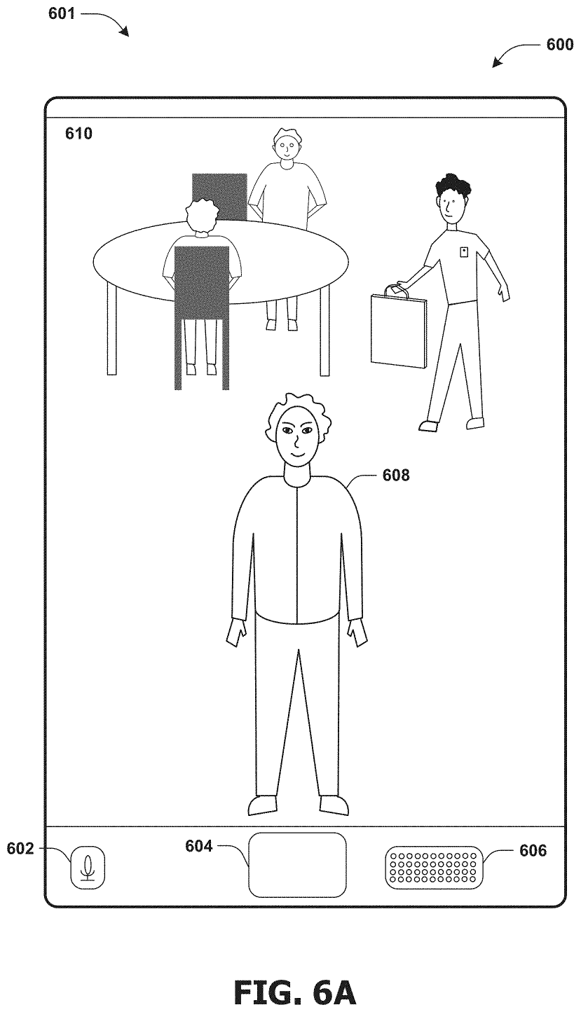

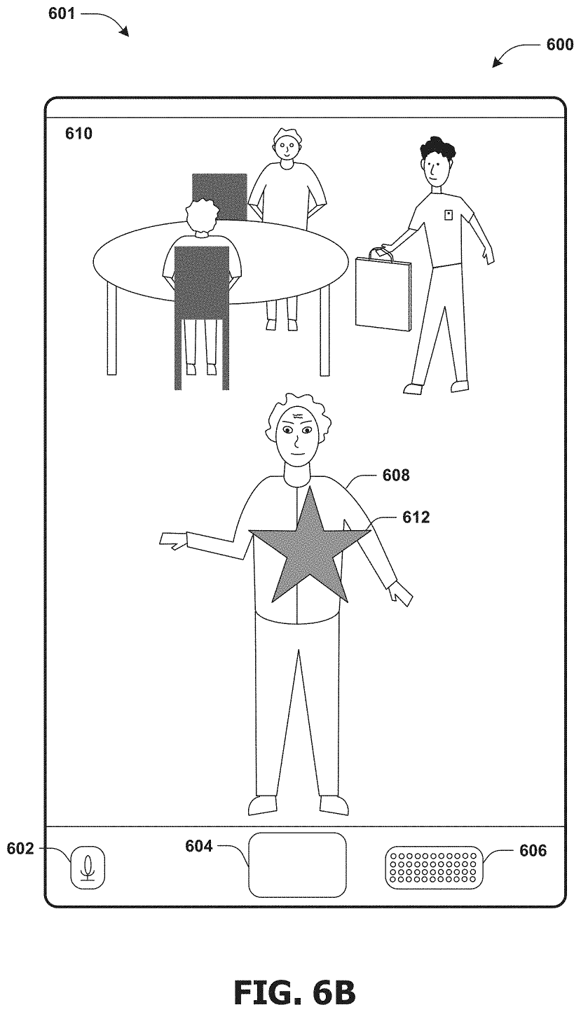

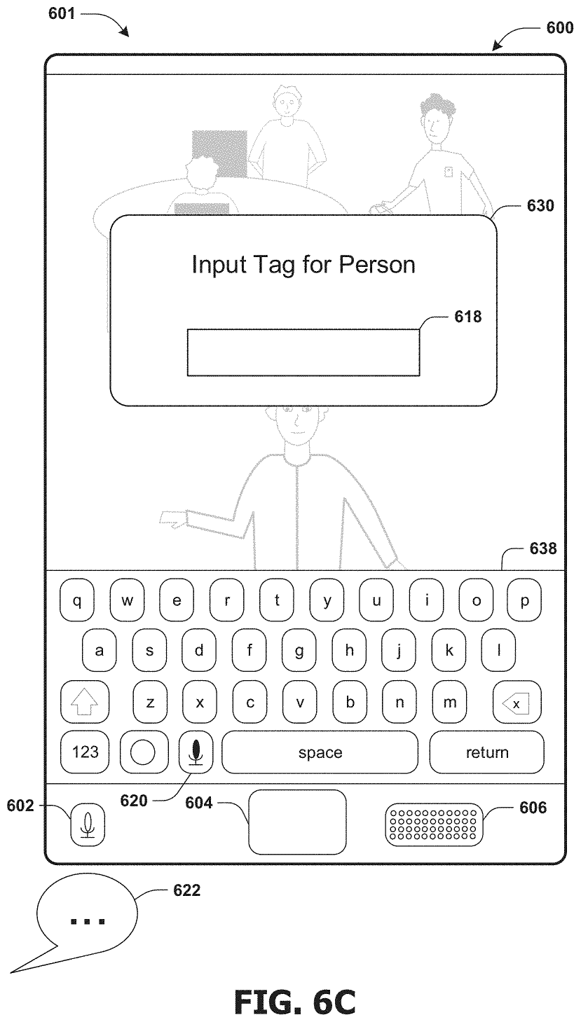

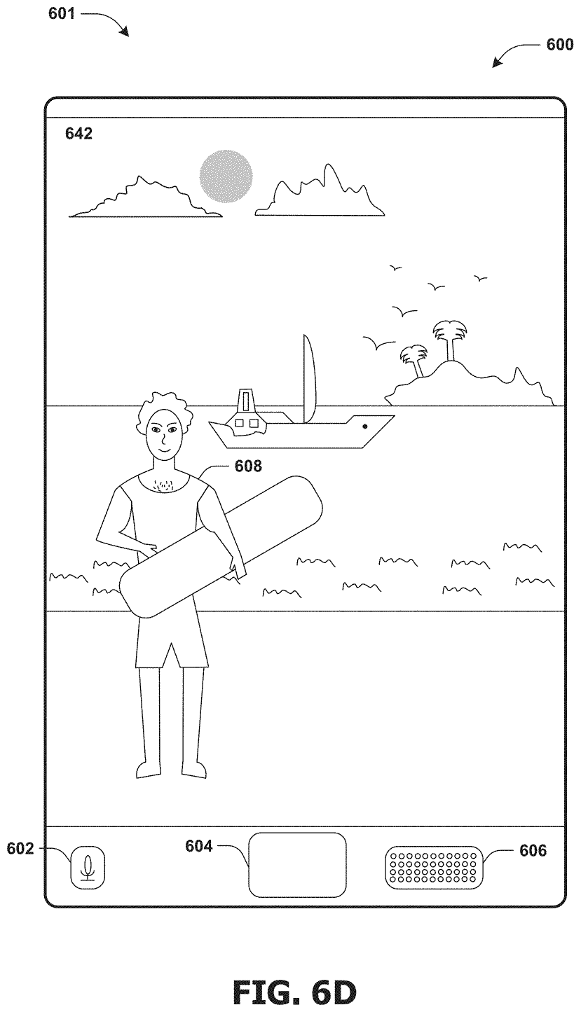

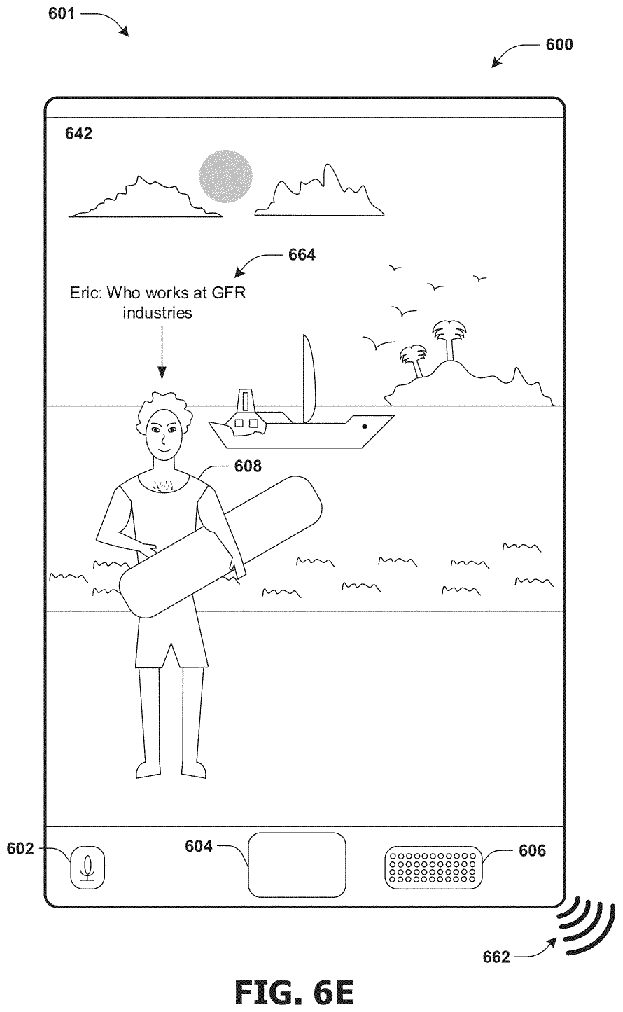

FIGS. 6A-6E illustrate a system 601 for tagging an object within an image and/or a video with information and/or later detecting the object and retrieving the information. A first user, such as user Jen, may use and/or interact with a first client device 600 for tagging objects with information. The first client device 600 may comprise a microphone 602, a button 604 and/or a speaker 606. In some examples, the first user and/or the first client device 600 may be at a social gathering (e.g., a conference for networking with people, such as colleagues and/or employees of various companies).

FIG. 6A illustrates the first client device 600 displaying a first real-time video 610. The first real-time video 610 may comprise a real-time representation of a view of a first camera. For example, the first real-time video 610 may be continuously recorded and/or continuously transmitted by the first camera (and/or by a communication module of the first camera). In some examples, the first camera may be mounted on and/or embedded within the first client device 600. Alternatively and/or additionally, the first camera may be wirelessly connected to the first client device 600. For example, the first camera may be mounted on and/or embedded within a wearable device, such as a smart glasses computer. In some examples, a first object 608 may be identified and/or detected within the first real-time video 610. For example, the first object 608 may correspond to a person conversing with the first user.

FIG. 6B illustrates the first client device 600 displaying an indicator 612 associated with the first object 608 (e.g., the person). For example, the indicator 612 may be generated and/or displayed responsive to identifying the first object 608 within the first real-time video 610. In some examples, the indicator 612 may comprise a graphical object (e.g., a star-symbol).

In some examples, a request to generate a first object tag associated with the first object 608 may be received via the first client device 600. For example, the request to generate the first object tag may be received via a selection of the indicator 612 associated with the first object 608. Alternatively and/or additionally, the request to generate the first object tag may be received via a voice command received via the microphone 602 of the first client device 600.

FIG. 6C illustrates the first client device 600 displaying a tag interface 630. For example, the tag interface 630 may be displayed responsive to receiving the request to generate the first object tag associated with the first object 608. Alternatively and/or additionally, the tag interface 630 may be displayed responsive to identifying the first object 608 within the first real-time video 610. The tag interface 630 may comprise a text-area 618 and/or a message “Input Tag for Person” instructing the first user to input first information associated with the first object 608. For example, the first information may be inputted using a keyboard 638 (e.g., a touchscreen keyboard and/or a physical keyboard). Alternatively and/or additionally, an audio recording 622 comprising speech may be received (from the user) via the microphone 602. For example, the audio recording 622 may comprise the first user saying “Eric who works at GFR industries”. The audio recording 622 may be transcribed (e.g., using one or more voice recognition and/or transcription techniques) to generate a transcription (e.g., “Eric who works at GFR industries”). The first object tag may be generated based upon the transcription (e.g., the first object tag may comprise “Eric: Who works at GFR industries”). In some examples, the audio recording 622 may be received via the microphone 602 responsive to a selection of a conversational interface selectable input 620 of the keyboard 638 corresponding to activating the microphone 602.

Alternatively and/or additionally, the first object 608 may be identified (automatically), the indicator 612 may be generated and/or displayed (automatically), the tag interface 630 may be displayed (automatically) and/or the first object tag associated with the first object 608 may be generated (automatically) responsive to one or more of determining that the person corresponding to the first object 608 is conversing with the first user, determining (using one or more image analysis techniques) that the person corresponding to the first object 608 is facing the first user and/or the first camera, determining (using the microphone 602) that the first user and the person corresponding to the first object 608 are speaking with each other and/or determining that the person corresponding to the first object 608 is within the first real-time video 610 and/or is facing the first user for a threshold duration of time.

In some examples, the first object tag may be generated (automatically) based upon recorded audio received via the microphone 602 while the person corresponding to the first object 608 is within the first real-time video 610 and/or while the person corresponding to the first object 608 is conversing with the first user. For example, the microphone 602 may be activated to receive the recorded audio responsive to receiving a request to record the recorded audio via the first client device 600. Alternatively and/or additionally, the microphone 602 may be activated (automatically) to receive the recorded audio responsive to one or more of identifying the first object 608, determining that the person corresponding to the first object 608 is conversing with the first user, determining (using one or more image analysis techniques) that the person corresponding to the first object 608 is facing the first user and/or the first camera and/or determining that the person corresponding to the first object 608 is within the first real-time video 610 and/or facing the first user for the threshold duration of time. In some examples, a transcription of the recorded audio may be generated. The first object tag may be generated based upon the transcription (e.g., the transcription may comprise the person corresponding to the first object 608 saying “Hi Jen, I'm Eric. I work at GFR industries”). Alternatively and/or additionally, the first object tag may be generated based upon the first real-time video 610. For example, the first real-time video 610 may be analyzed to identify an indication of a name of the person (e.g., a nametag comprising “Eric”) and/or a company that the person works for (e.g., a company shirt with “GFR industries” embedded on the company shirt).

In some examples, the first object tag and/or object information associated with the first object 608 may be stored. For example, the first object tag and/or the object information may be stored in device memory of the first client device 600. Alternatively and/or additionally, the first object tag and/or the object information may be stored in a server. For example, the first object tag and/or the object information may be stored in a first user profile associated with a first user account associated with the first user and/or the first client device 600.

In some examples, the object information may comprise visual information associated with the first object 608 (e.g., the person). For example, the object information may comprise the type of object (e.g., a person) of the first object 608. Alternatively and/or additionally, the object information may comprise one or more images comprising the first object 608 (e.g., one or more video frames, of the first real-time video 610, comprising the person). Alternatively and/or additionally, the object information may comprise one or more visual characteristics associated with the first object 608 such as one or more of an appearance of the person, one or more facial characteristics of the person, one or more parameters of the person, one or more colors of the person, one or more measurements (e.g., size measurements, depth measurements, width measurements, etc.) of the person, etc.

FIG. 6D illustrates the first client device 600 displaying a second real-time video 642. The second real-time video 642 may comprise a real-time representation of a view of the first camera (and/or a second camera). For example, the second real-time video 642 may be continuously recorded and/or continuously transmitted by the first camera (and/or by the communication module of the first camera). For example, the second real-time video 642 may be recorded and/or transmitted after the first object tag is generated.

In some examples, the first object 608 may be identified within the second real-time video 642 based upon the second real-time video 642 and/or the object information associated with the first object 608. For example, the second real-time video 642 (and/or one or more video frames of the second real-time video 642) may be analyzed based upon the object information to determine that the second real-time video 642 (and/or one or more video frames of the second real-time video 642) comprises the first object 608. The second real-time video 642 (and/or one or more video frames of the second real-time video 642) may be analyzed using one or more object recognition techniques and/or one or more facial recognition techniques to determine that the second real-time video 642 (and/or one or more video frames of the second real-time video 642) comprises the first object 608 (e.g., the person).

FIG. 6E illustrates the first client device 600 displaying a representation 664 of the first object tag associated with the first object 608. For example, the representation 664 of the first object tag may be displayed responsive to identifying the first object 608 within the second real-time video 642. Alternatively and/or additionally, the representation 664 of the first object tag may be overlaid onto the second real-time video 642 responsive to identifying the first object 608 within the second real-time video 642. In some examples, the representation 664 of the first object tag may be overlaid onto a region of the second real-time video 642 adjacent to the first object 608. Alternatively and/or additionally, the representation 664 of the first object tag may be overlaid onto a region of the second real-time video 642 comprising the first object 608.

Alternatively and/or additionally, the representation 664 of the first object tag may be (automatically) displayed via a display device (e.g., an HUD). For example, a client device (e.g., a wearable device, such as one or more of a smart glasses computer, a smart watch, etc.) different than the first client device 600 may comprise the display device.

Alternatively and/or additionally, an audio message 662, indicative of the first object tag, may be output via the speaker 606 of the first client device 600 responsive to identifying the first object 608 within the second real-time video 642. Alternatively and/or additionally, the audio message 662 may be output via a pair of headphones connected to the first client device 600, a Bluetooth speaker connected to the first client device 600, etc. For example, the audio message 662 may comprise speech comprising (and/or representative of) the first object tag (e.g., “Eric who works at GFR industries”). Alternatively and/or additionally, the audio message 662 may comprise speech comprising (and/or representative of) a modified version of the first object tag.

It may be appreciated that the disclosed subject matter may assist a user (e.g., and/or a client device associated with the user) in tagging an object (e.g., a person, a shirt, a tree, etc.) within a view of a camera with information and/or being reminded of the information a next time that the camera has a view of the object and/or captures an image of the object.

Implementation of at least some of the disclosed subject matter may lead to benefits including, but not limited to, an improved usability, efficiency and/or speed of a system for tracking real-world objects (that receives images captured by a camera and displays the images) by identifying, tracking and/or tagging real-world objects and then displaying, via the display, one or more tags applicable to a situation (e.g., as a result of automatically identifying an object within an image and/or a real-time video comprising a real-time representation of a view of the camera, as a result of enabling the user and/or the client device to generate an object tag associated with the object, as a result of analyzing and/or monitoring captured images and/or recorded real-time videos to identify the object, as a result of displaying a representation of the object tag responsive to identifying the object and/or outputting an audio message indicative of the object tag responsive to identifying the object, etc.).

In some examples, at least some of the disclosed subject matter may be implemented on one or more client devices, and in some examples, at least some of the disclosed subject matter may be implemented on a server (e.g., hosting a service accessible via a network, such as the Internet).

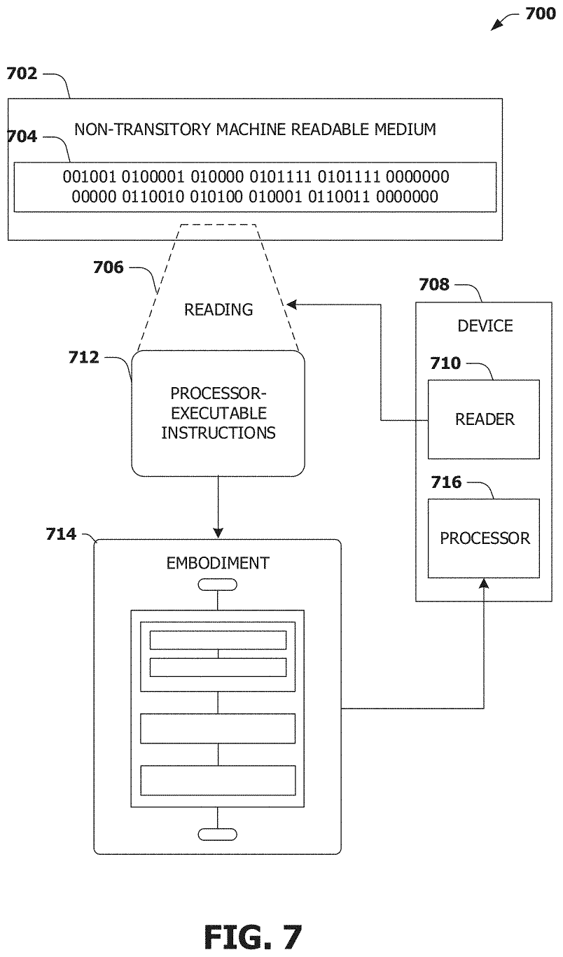

FIG. 7 is an illustration of a scenario 700 involving an example non-transitory machine readable medium 702. The non-transitory machine readable medium 702 may comprise processor-executable instructions 712 that when executed by a processor 716 cause performance (e.g., by the processor 716) of at least some of the provisions herein (e.g., embodiment 714). The non-transitory machine readable medium 702 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 702 stores computer-readable data 704 that, when subjected to reading 706 by a reader 710 of a device 708 (e.g., a read head of a hard disk drive, or a read operation invoked on a solid-state storage device), express the processor-executable instructions 712. In some embodiments, the processor-executable instructions 712, when executed, cause performance of operations, such as at least some of the example method 400 of FIG. 4, for example. In some embodiments, the processor-executable instructions 712 are configured to cause implementation of a system, such as at least some of the example system 501 of FIGS. 5A-5E and/or the example system 601 of FIGS. 6A-6E, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving a first image captured via a first camera;
analyzing the first image to identify a first object within the first image;
generating an object tag comprising information associated with the first object;
storing the object tag and object information associated with the first object;
receiving a second image captured via a second camera;
identifying, based upon at least one of the second image or the object information, the first object within the second image; and
displaying, via a display device, a representation of the object tag.

2. The method of claim 1, wherein:
the first image corresponds to a portion of a first real-time video that is continuously transmitted by the first camera; and
the second image corresponds to a portion of a second real-time video that is continuously transmitted by the second camera.

3. The method of claim 1, comprising receiving an input via a client device associated with the first camera, wherein the object tag is generated based upon the input.

4. The method of claim 3, wherein the input corresponds to an audio recording received via a microphone associated with the client device, the method comprising transcribing the audio recording to generate the object tag.

5. The method of claim 3, wherein the input corresponds to a text-input received via the client device.

6. The method of claim 3, wherein the client device is wirelessly connected to at least one of the first camera or the second camera.

7. The method of claim 1, wherein the object information comprises at least one of:
a type of object of the first object;
the first image;
a third image comprising the first object;
a portion of the first image corresponding to the first object;
a portion of the third image corresponding to the first object; or
one or more visual characteristics of the first object.

8. The method of claim 1, wherein the object information comprises at least one of:
a location associated with the first object; or
audio recorded via a microphone during a time that the first image is captured.

9. The method of claim 8, comprising:
determining a second location associated with the second image; and
comparing the second location with the location associated with the first object to determine a distance between the second location and the location, wherein the identifying the first object within the second image is performed based upon the distance.

10. The method of claim 8, comprising:
recording second audio via the microphone during a time that the second image is captured; and
comparing the second audio with the audio to determine an audio similarity between the second audio and the audio, wherein the identifying the first object within the second image is performed based upon the audio similarity.

11. The method of claim 1, wherein the displaying the representation of the object tag comprises:
displaying a real-time video, received via the second camera, via the display device; and
overlaying the representation of the object tag onto the real-time video.

12. The method of claim 1, wherein the first camera is the same as the second camera.

13. The method of claim 1, wherein the generating the object tag is performed responsive to receiving a request to generate the object tag.

14. A computing device comprising:
a processor; and
memory comprising processor-executable instructions that when executed by the processor cause performance of operations, the operations comprising:
receiving a first image captured via a first camera;
analyzing the first image to identify a first object within the first image;
generating an object tag comprising information associated with the first object;
storing the object tag and object information associated with the first object;
receiving a second image captured via a second camera;
identifying, based upon at least one of the second image or the object information, the first object within the second image; and
determining, based upon the second image, a location of the first object.

15. The computing device of claim 14, wherein:
the first image corresponds to a portion of a first real-time video that is continuously transmitted by the first camera; and
the second image corresponds to a portion of a second real-time video that is continuously transmitted by the second camera.

16. The computing device of claim 14, the operations comprising receiving an input via a client device associated with the first camera, wherein the object tag is generated based upon the input.

17. The computing device of claim 16, wherein the input corresponds to an audio recording received via a microphone associated with the client device, the operations comprising transcribing the audio recording to generate the object tag.

18. The computing device of claim 16, wherein the input corresponds to a text-input received via the client device.

19. A non-transitory machine readable medium having stored thereon processor-executable instructions that when executed cause performance of operations, the operations comprising:
receiving a first image captured via a first camera;
analyzing the first image to identify a first object within the first image;
generating an object tag comprising information associated with the first object;
storing the object tag and object information associated with the first object;
receiving a second image captured via a second camera;
identifying, based upon at least one of the second image or the object information, the first object within the second image; and
outputting, via a speaker, an audio message indicative of the object tag.

20. The non-transitory machine readable medium of claim 19, wherein:
the first image corresponds to a portion of a first real-time video that is continuously transmitted by the first camera; and
the second image corresponds to a portion of a second real-time video that is continuously transmitted by the second camera.
